(19) United States
(12) Patent Application Publication
(10) Pub. No.: US 2003/0182941 A1
(43) Pub. Date: Oct. 2, 2003

(54) Combustion turbine inlet for air cooling via refrigerated liquid hydrocarbon fuel vaporization

(76) Inventors: John Stephen Andrepont, Naperville, IL (US); Per A Duus, Chicago, IL (US); Robert J Golueke, Naperville, IL (US)

Correspondence Address: Marshall Gerstein & Borun, Sears Tower, Suite 6300, 233 S. Wacker Drive, Chicago, IL, 60606-6357, US

(21) Appl. No.: 10/344,739

(22) PCT Filed: Feb. 25, 2002
(86) PCT No.: PCT/US02/05383

(51) Int. Cl. F02C 1/00

(52) U.S. Cl. 60/728

(57) ABSTRACT

Liquid fuel for a power plant is vaporized against a heat-exchange fluid, cooling the fluid. A re-circulation circuit enables cooled fluid to be re-directed back for further cooling, when desired. The cooled fluid is used to cool the inlet air for a combustion turbine. Some of the cooled fluid is periodically directing to the bottom of a stratified tank, from which it can be drawn during times when the need for or value of cooling the inlet air is higher. The fluid is warmed as it cools the inlet air, and may be returned for use in vaporizing additional fuel, or returned to the top of the stratified tank.

### BACKGROUND OF THE INVENTION

The present invention relates generally to power plants and more particularly to power plants that use combustion turbines that are powered by hydrocarbon gases, such as natural gas or propane.

The hydrocarbon gases that are used to power such facilities often arrive in liquified form and are vaporized prior to use. Vaporization is conventionally done by burning some of the fuel or by warming the liquid against some other heat source.

The performance of combustion turbines is affected by a number of factors. One factor is ambient air pressure. Air pressure is affected by altitude, weather-induced changes in barometric pressure, and pressure losses associated with the air flow through inlet ducts, filters, etc.

The performance of combustion turbines is also affected by temperature of the inlet air. Combustion turbines typically exhibit a loss in power output as the ambient air temperature rises. Combustion turbine performance can be defined to be 100% of its “rated” value when operating at ISO conditions of sea level and 15° C. (59° F.). Although the actual relationship between temperature and performance varies, power outlet typically drops to 80 or 85% of its ISO rated output when the inlet air temperature rises to around 35° C. (95° F.). On the other hand, when the inlet air temperatures is only 7° C. (45° F.), power output may increase to 105% of its ISO rated output, a 30% improvement over high-temperature performance.

The demand for electric power (and the value of electricity) is often greatest at those times of high ambient air temperature, when air-conditioning loads are maximized. Co-pending application Ser. No. 09/591,250, filed Jun. 9, 2000, describes how a heat-exchange fluid stored in a stratified tank may be used to cool the inlet air at such facilities.

### SUMMARY OF THE INVENTION

The present invention effectively captures the “cold” of refrigerated liquid hydrocarbon fuel and utilizes it to cool the inlet air directed to a combustion turbine. By reducing the need to either burn off some of the fuel for vaporization or wasting the “cold” against some other heat source, and by reducing the need for an independent cooling source, the present invention enables a power generation facility to operate more efficiently and cost effectively.

The refrigerated liquid hydrocarbon fuel that is used to fuel the power generation facility is vaporized against a heat-exchange fluid in a vaporizer. The heat-exchange fluid could be any of a variety of liquids, including water or a methanol/water solution. During vaporization, the heat-exchange fluid cools. A re-circulation circuit connecting the downstream side of the vaporizer with its upstream side may be provided for selectively re-circulating cooled heat-exchange fluid back to the vaporizer for further cooling.

Some of the cooled heat-exchange fluid is periodically directed to storage in a storage facility. Preferably, the heat-exchange fluid is stored in a stratified condition, with the cooled heat-exchange fluid being directed into the bottom of the storage facility. When the fluid is needed for vaporizing the liquid hydrocarbon fuel, it is drawn from the top of the storage facility.

Cooled heat-exchange fluid is delivered to an inlet air cooler associated with the combustion turbine. The cooled heat-exchange fluid may come directly from the vaporizer, or from storage, or from both in combination. Periodically, the heat-exchange fluid used to cool the inlet air may be drawn from cooled heat-exchange fluid in storage. In any event, the inlet air cooler cools the inlet air to the combustion turbine, improving the efficiency of the turbine.

The heat-exchange fluid warns as it cools the inlet air. The warmed heat-exchange fluid may be returned to the vaporizer for use in vaporizing additional liquified fuel. Periodically, some of the warmed heat-exchange fluid may be returned to storage. When the heat-exchange fluid is stored in a stratified condition, the warmed heat-exchange fluid is returned to the top of the storage facility, from which it can later be drawn off as needed for use in the vaporizer.

### BRIEF DESCRIPTION OF THE DRAWING

The invention can be understood more clearly by referring to the accompanying drawing, in which:

FIG. 1 is a schematic view of a power facility that includes an embodiment of the present invention.

### DETAILED DESCRIPTION OF THE DRAWING

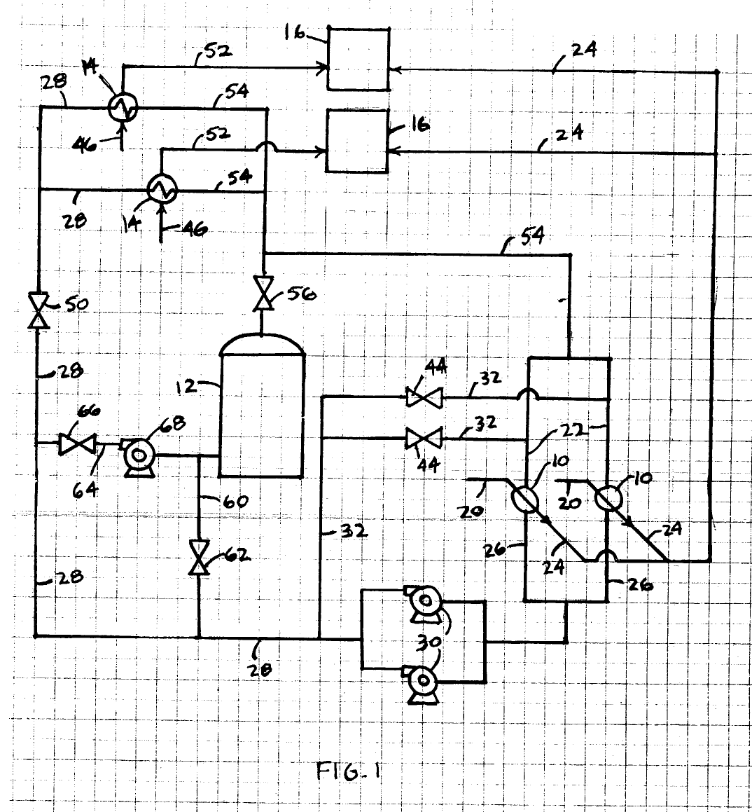

The power facility that has been illustrated in FIG. 1 includes a set of vaporizers 10, a storage facility in the form of a stratified tank 12, and a pair of inlet air coolers 14 for a pair of combustion turbines 16. The combustion turbines operate on a hydrocarbon fuel, such as natural gas or propane. The fuel is provided in refrigerated, liquid form, such as liquified natural gas (LNG) or liquified petroleum gas (LPG).

Before it can be used to fuel the combustion turbines 16, the liquified hydrocarbon fuel must be vaporized from its liquid state into a gaseous state. The illustrated vaporizers 10 can be used to vaporize a refrigerated fuel. Vaporization is achieved by putting the liquid fuel in thermal contact with a warmer heat-exchange fluid, without freezing the heat-exchange fluid. In some applications, such as the one illustrated, the vaporizer can be a vertical shell-and-tube heat exchanger designed to handle a flow rate of 1200 m³/hr of heat-exchange fluid. Other kinds and sizes of heat exchangers can also be used and the number of vaporizers can vary.

A variety of liquids can be used as the heat-exchange fluid. In some situations, water can be used. Sometimes, the heat-exchange fluid can be a solution containing methanol and water, such as one containing 30% (by weight) methanol and 70% (by weight) water. Other possibilities include a solution containing one or more of sodium chloride, calcium chloride, potassium acetate, potassium formate, potassium nitrate, sodium nitrate, sodium nitrite, ethylene glycol, propylene glycol, aqueous ammonia, or anhydrous ammonia. While it may sometimes be preferable to use a single heat-exchange fluid throughout the system, in other situations it may be preferable to utilize different heat-exchange fluids in different parts of the system.

In the illustrated embodiment of the invention, refrigerated liquid fuel enters the vaporizers 10 through liquid supply lines 20 at a temperature of approximately −160° C. (−260° F.). Within the vaporizers, the refrigerated liquid fuel is placed in thermal contact with the relatively warm heat-exchange fluid that is supplied to the vaporizers through warm-fluid supply lines 22. In this situation, the temperature of the heat-exchange fluid in the warm-fluid supply lines is about 20° C. (70° F.). The thermal contact between the warm heat-exchange fluid and the liquid fuel vaporizes the refrigerated liquid fuel into gaseous fuel while the heat-exchange fluid cools. The gaseous fuel exits the vaporizer through gas lines 24, through which it is directed to the combustion turbines 16. The cooled heat-exchange fluid exits the vaporizers through low-stage supply lines 26. Here, the temperature of the gaseous fuel is about 10° C. (50° F.), and the temperature of the cooled heat-exchange fluid is around 0° C. (30° F.).

Intermediate-stage fluid lines 28 can be used to direct cooled heat-exchange fluid to either the stratified tank 12 or to the inlet air coolers 14. In some instances, the temperature of the cooled heat-exchange fluid may be higher than desired. Thus, it may be desirable to provide a secondary cooler to cool the heat-exchange fluid to temperatures lower than those provided by a single pass through the vaporizers 10. One useful way to further cool the heat-exchange fluid is with a re-circulation circuit such as the one illustrated.

The illustrated re-circulation circuit includes a vaporizer pump 30 and re-circulation pipes 32 that can be used to selectively re-circulate cooled heat-exchange fluid back to the upstream side of the vaporizers 10 for further cooling.

In the illustrated embodiment of the invention, the re-circulation pipes 32 include a separate pipe for each vaporizer 10. Each pipe is provided with a re-circulation valve 44 that controls the flow of heat-exchange fluid to its respective vaporizer. Re-circulating some of the cooled heat-exchange fluid back for a second pass through the vaporizers causes the temperature of the cooled heat-exchange fluid in the low-stage supply lines 26 to decrease.

The inlet air coolers 14 are adapted to utilize the cooled heat-exchange fluid to cool inlet air for the combustion turbines 16. The air coolers may be, for example finned tube heat exchangers. The cooled heat-exchange fluid may be supplied from the intermediate-stage line 28. An auxiliary air cooler (not illustrated) may be provided to supplement the cooling of the inlet air for the combustion turbine.

In the illustrated embodiment of the invention, ambient air enters the inlet air coolers 16 through ducts 46. In some situations, the temperature of the ambient air may be as high as 35° C. (95° F.) or more. Within the air coolers, the ambient air is placed in thermal contact with the relatively cool heat-exchange fluid from the intermediate-stage fluid supply line 28. An air cooler valve 50 on the intermediate-stage lines 28 controls the flow of heat-exchange fluid. The type and position of the air cooler valve may vary.

In the inlet air coolers 14, the thermal contact between the warm ambient air from the ducts 46 and the cool heat-exchange fluid from the intermediate-stage line 28 cools the inlet air while warming the heat-exchange fluid. The cooled inlet air, preferably at a temperature of 5° C. (45° F.) or less, is then provided to the combustion turbines 16 through turbine inlets 52. Using inlet air at a temperature of around 5° C. (45° F.), instead of a temperature of 35° C. (95° F.), can increase the power output of a combustion turbine by 30% or more.

The warmed heat-exchange fluid exits the inlet air coolers 14 through return lines 54. In the illustrated embodiment of the invention, the temperature of the warmed heat-exchange fluid in the return lines may be around 20° C. (70° F.). One branch of the return lines leads back to the warm-fluid supply lines 22. Another branch leads to the top of the stratified tank 12. A tank valve 56 on that branch of the return lines controls how much of the warmed heat exchange-fluid is directed to the stratified tank. The type and location of the tank valve may vary.

Cooled heat-exchange fluid that is not immediately needed for cooling inlet air can be sent to the stratified tank 12 through a cold supply line 60. The cold supply line communicates with the bottom of the stratified tank, in which the heat-exchange fluid is stored in a stratified condition. In some situations, such as the one illustrated, it may be desirable for the tank to have a capacity of approximately 50,000-100,000 m³. In this situation, the tank should be externally insulated and should include top and bottom distribution systems specifically designed to encourage thermal stratification of the stored heat-exchange fluid.

Cold, high-density fluid is stored in the bottom of the tank 12 and warm, low-density fluid is stored in the top of the tank, resulting in stratified storage. When temperatures below around 4° C. (39° F.) are desired, use of a fluid other than plain water may be desirable because the temperature/density relationship of plain water makes it difficult to preserve a stratified condition below these temperatures.

A storage valve 62 on the cold supply line 60 can be used to control when and how much cooled heat-exchange fluid is directed to the stratified tank 12. Commonly, cooled heat-exchange fluid is sent to storage during evening hours when the value of or need for cooling the inlet air for the combustion turbines 16 is low. Sending cooled heat-exchange fluid to the stratified tank builds up a reserve of cooled heat-exchange fluid that can be drawn upon during hours when the vaporization of the refrigerated liquid fuel does not provide sufficient cooling to cool the inlet air to the desired level.

When desired, warm heat-exchange fluid can be drawn from the top of the stratified tank 12 through the return line 54. A pump may be provided, if necessary. The warm heat-exchange fluid can be directed to vaporizers 10 for cooling and then returned, after it has been cooled, to the bottom of the stratified tank.

The reserve of cooled heat-exchange fluid can be withdrawn from the bottom of the stratified tank 12 to the inlet air coolers 14 through a supplementary supply line 64 that leads from the bottom of the tank to the intermediate-stage line 28. A secondary valve 66 on the supplementary supply line controls when and how much cooled heat-exchange fluid is withdrawn from the stratified tank. A secondary pump 68 is preferably provided on the supplementary supply line to provide the desired pressure to the cooled heat-exchange fluid being withdrawn from storage. The type and position of the secondary valve and the secondary pump can be varied.

This detailed description has been provided for illustrative purposes, not as a limit on the scope of the invention. The full scope of the invention is set forth in the following claims.

What is claimed is:

1. A method comprising the steps of:
vaporizing a refrigerated liquid hydrocarbon fuel against a liquid heat-exchange fluid, causing the heat-exchange fluid to cool;
periodically directing some of the cooled heat-exchange fluid to storage; and
using the cooled heat-exchange fluid to cool inlet air for a combustion turbine.

2. A method as recited in claim 1, in which the refrigerated liquid hydrocarbon fuel is liquified natural gas.

3. A method as recited in claim 1, in which the refrigerated liquid hydrocarbon fuel is liquified petroleum gas.

4. A method as recited in claim 1, in which the liquid heat-exchange fluid is water.

5. A method as recited in claim 1, in which the liquid heat-exchange fluid is a methanol/water solution.

6. A method as recited in claim 1, in which the liquid heat-exchange fluid is a solution containing at least one of one of sodium chloride, calcium chloride, potassium acetate, potassium formate, potassium nitrate, sodium nitrate, sodium nitrite, ethylene glycol, propylene glycol, aqueous ammonia, and anhydrous ammonia.

7. A method as recited in claim 1, in which the heat-exchange fluid is stored in a stratified condition.

8. A method as recited in claim 1, in which a secondary cooler is provided to supplement the cooling of the heat-exchange fluid.

9. A method as recited in claim 1, in which cooled heat-exchange fluid is periodically re-circulated against the liquid hydrocarbon fuel.

10. A method as recited in claim 1, in which the heat-exchange fluid used to cool the inlet air is periodically drawn from cooled heat-exchange fluid in storage.

11. A method as recited in claim 1, in which some of the heat-exchange fluid that is used to cool the inlet air is periodically returned to storage.

12. An apparatus comprising:
a vaporizer arranged to vaporize liquid hydrocarbon fuel against a liquid heat-exchange fluid, causing the heat-exchange fluid to cool;
a storage facility arranged to receive at least some of the cooled heat-exchange fluid; and
a combustion turbine with an inlet air cooler adapted to utilize the cooled heat-exchange fluid to cool inlet air for the turbine.

13. An apparatus as recited in claim 12, in which the liquid hydrocarbon fuel is liquified natural gas.

14. An apparatus as recited in claim 12, in which the liquid hydrocarbon fuel is liquified petroleum gas.

15. An apparatus as recited in claim 12, in which the storage facility is a stratified tank.

16. An apparatus as recited in claim 12, further comprising a secondary cooler arranged to supplement the cooling of the liquid heat-exchange fluid.

17. An apparatus as recited in claim 12, further comprising a re-circulation circuit comprising a pump and piping for selectively re-circulating cooled heat-exchange fluid back to the vaporizer.

18. An apparatus as recited in claim 12, further comprising piping for selectively withdrawing cooled heat-exchange fluid from the storage facility to the inlet air cooler.

19. An apparatus as recited in claim 12, further comprising piping for selectively directing heat-exchange fluid from the air cooler to the storage facility.
